(19) United States
(12) Patent Application Publication
(10) Pub. No.: US 2009/0188082 A1
(43) Pub. Date: Jul. 30, 2009

(54) Adjustable glass hinge

(76) Inventor: Shih-Chang Huang, Daliao Shiang (TW)

Correspondence Address: Frenkel & Associates, P.C., Suite 330, 3975 University Drive, Fairfax, VA, 22030, US

(21) Appl. No.: 12/011,248

(22) Filed: Jan. 25, 2008

(51) Int. Cl. E05D 5/00

(52) U.S. Cl. 16/382

(57) ABSTRACT

An adjustable glass hinge mainly includes a fastening assembly fastened to a door frame and a clipping plate assembly to clip a glass panel. The fastening assembly includes a fastening seat, two bucking elements disposed from one side in the fastening seat and coupled respectively with an elastic element, a pintle running through another side of the fastening seat and a seat board fastened to the fastening seat. The clipping plate assembly has a first clip plate and a second clip plate that are coupled together, two pads held on an inner side of the first and second clip plates and a clipping blade to hold and confine two directing members. Alignment of the glass panel can be accomplished quickly.

### FIELD OF THE INVENTION

The present invention relates to an adjustable glass hinge and particularly to hinge that can fine tune the position of a glass panel relative to a door frame to do alignment without removing a covering plate.

### BACKGROUND OF THE INVENTION

A conventional hinge for a glass panel 21 (referring to FIG. 1 by R.O.C. patent application No. 094200457) has a fastening seat 10 fastened to a door frame 20 and a clipping assembly 11 clipping the glass panel 21. The clipping assembly 11 includes a first clip plate 111 and a second clip plate 112. The first clip plate 111 has a fastening boss 113 on an inner side. The fastening boss 113 has two opposing coupling troughs 114 and two sets of first concave portions 115 at an upper end and a lower ends thereof to hold a pintle 12. Each coupling trough 114 holds a clipping member 14 through adjusting screws 13. The clipping member 14 has a second concave portion 141 corresponding to the first concave portion 115 to clip one end of the pintle 12. The second clip plate 112 is coupled with a covering plate 116 on an outer side. For aligning the glass panel 21, referring to FIG. 2, the adjusting screws 13 on the clipping member 14 are unfastened through a tool, then the glass panel 21 is fine tuned against the position of the door frame 20. Finally the adjusting screws 13 are fastened tightly, and the covering plate 116 is coupled on the outer side of the second clip plate 112, and a screw 117 is fastened. Although the glass panel 21 can be aligned, the process is tedious and time-consuming.

### SUMMARY OF THE INVENTION

The primary object of the present invention is to provide an adjustable glass hinge to hinge a glass panel on an inner side of a door frame. It has a clipping plate assembly with an adjusting screw at one side that is exposed when the glass panel is opened by swiveling from the door frame so that the adjusting screw can be rapidly unfastened to fine tune the position of the glass door relative to the door frame.

To achieve the foregoing object, the adjusting glass hinge of the invention mainly includes a fastening assembly and a clipping plate assembly.

The fastening assembly includes a fastening seat, two bucking elements held at one side of the fastening seat and coupled respectively with an elastic element, a pintle running through the one side of the fastening seat that has an upper end and a lower end with a stem formed respectively thereon and a seat board fastened to the fastening seat.

The clipping plate assembly has a first clip plate and a second clip plate that are coupled together, two pads held on an inner side of the first and second clip plates and a clipping blade to hold and confine two directing members. The first clip plate has a fastening boss extended from an inner side. The fastening boss has two opposing latch troughs to support the stems and directing members at the upper end and lower end of the pintle. The two latch troughs have respectively one side with a first screw hole and a second screw hole formed vertically thereon.

By means of the construction set forth above, when the glass panel is installed or opened by swiveling to do alignment, the adjusting screws held in the first and second screw holes can be fine tuned through a tool. Then the position of the glass panel relative to the door frame can be adjusted, and the adjusting screws can be fastened tightly again without removing a covering plate. Thus the glass panel can be aligned quickly.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a conventional glass hinge.

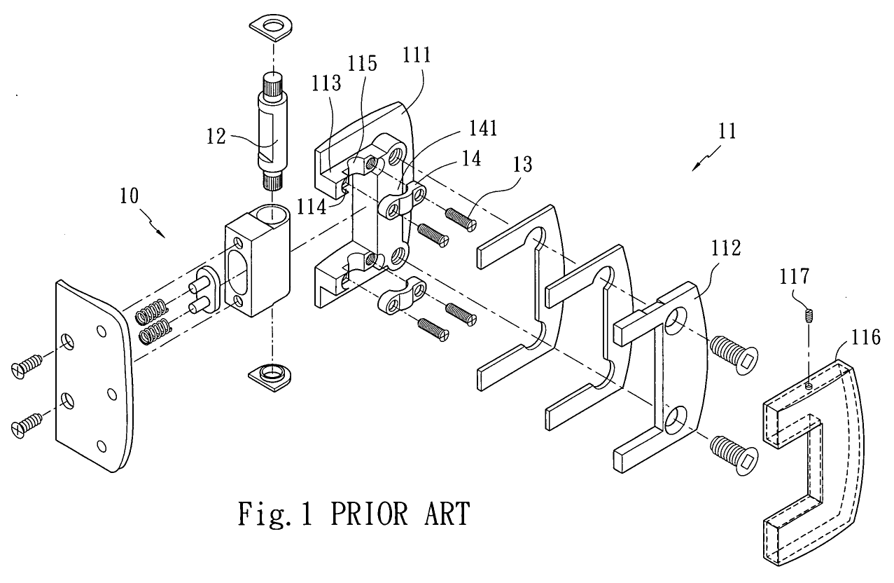

FIG. 2 is a schematic view for adjusting and aligning a glass panel according to FIG. 1.

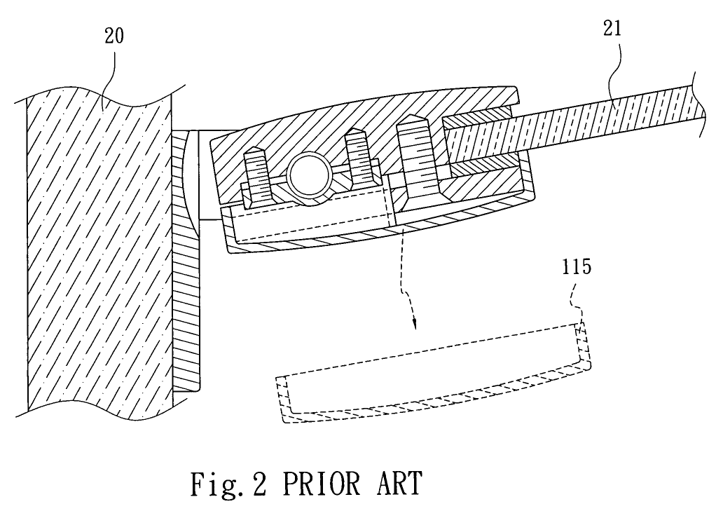

FIG. 3 is an exploded view of the invention.

FIG. 4A is a perspective view of the invention in an assembled condition.

FIG. 4B is a cross section taken on line 4B-4B in FIG. 4A.

FIG. 4C is a cross section taken on line 4C-4C in FIG. 4B.

FIG. 5 is a schematic view of the invention for adjusting a tilted glass panel.

FIG. 6 is a schematic view of the invention in an operating condition for adjusting a tilted glass panel.

FIG. 7 is a top view of the invention after the glass panel has been adjusted and aligned.

### DETAILED DESCRIPTION OF THE PREFERRED EMBODIMENT

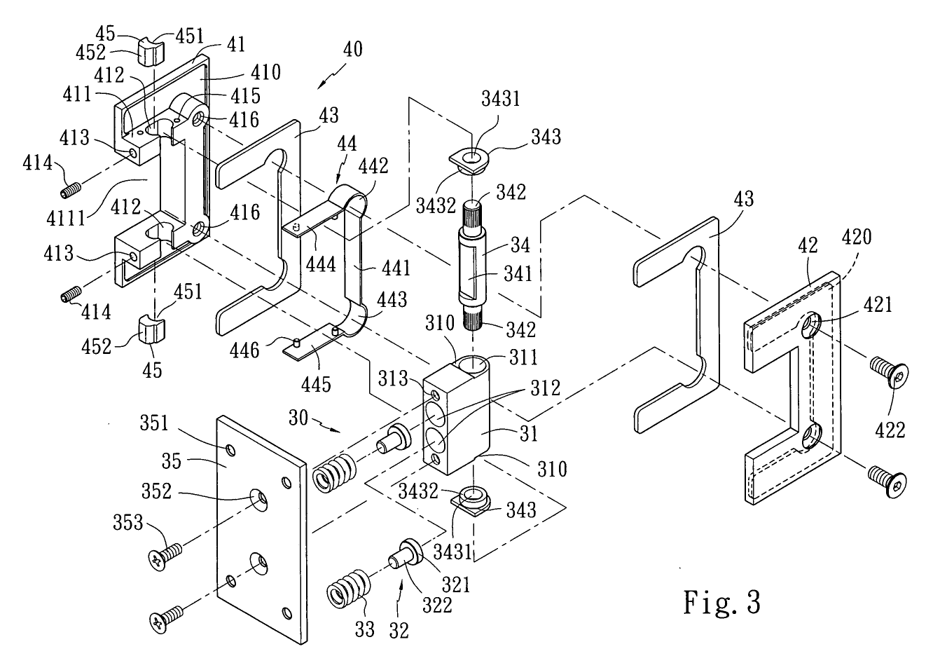

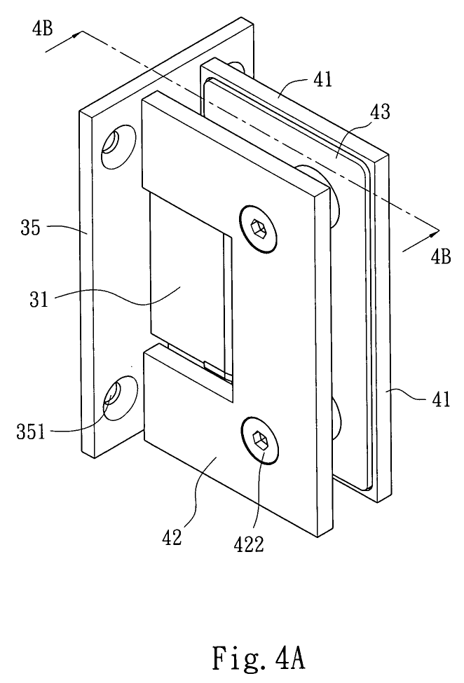

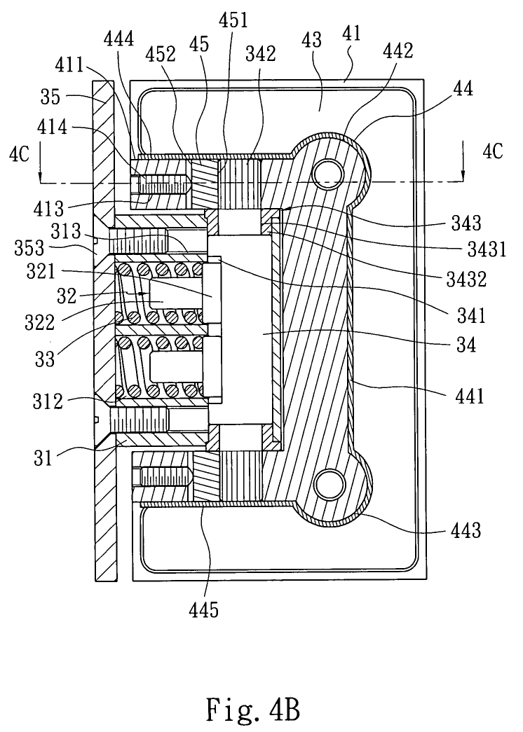

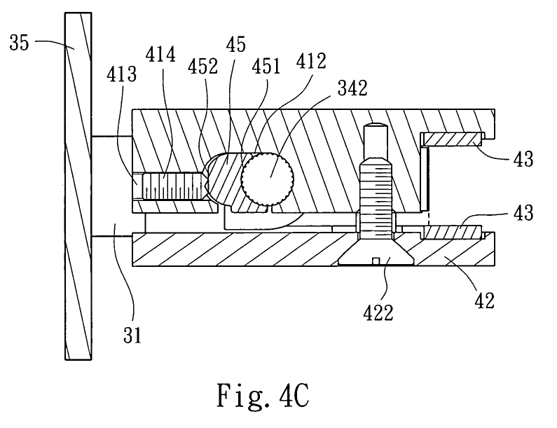

Please refer to FIGS. 3 through 4C for an embodiment of the invention. The adjusting glass hinge of the invention mainly includes a fastening assembly 30 and a clipping plate assembly 40.

The fastening assembly 30 is fastened to a door frame 50, and mainly includes a fastening seat 31, two bucking elements 32 disposed in the fastening seat 31 from one side thereof and coupled respectively with an elastic element 33, a pintle 34 running through another side of the fastening seat 31 and a seat board 35 fastened to the fastening seat 31 and anchored on the door frame 50.

The fastening seat 31 has a recess 310 at an upper side and a lower side with a pintle hole 311 running through, and two opposing through holes 312 at the one side leading vertically to the pintle hole 311 and two fastening holes 313 at the outer sides of the two through holes 312.

The two bucking elements 32 are held in the two through holes 312 with one end formed a pressing head 321 and another end formed a strut 322 at a diameter smaller than the pressing head 321 to be coupled with the elastic element 33 on the periphery thereof. Hence the two bucking elements 32 are movable in the two through holes 312 through the elastic force of the elastic element 33.

The pintle 34 runs through the pintle hole 311 and has a flat surface 341 on an outer side in the middle portion to be pressed by the pressing head 321 of the two bucking elements 32 to confine the pintle 34 at a desired location. The pintle 34 further has an upper end and a lower end formed respectively a stem 342 with a frictional surrounding surface formed thereon to be coupled with a sealing cap 343 on the recess 310 of the fastening seat 31. The sealing cap 343 has a jutting ring 3432 with an aperture 3431 formed thereon to engage with the pintle 34 after having run through the pintle hole 311.

The seat board 35 has a plurality of apertures 351 on the periphery to be fastened to the door frame 50, and sunken holes 352 in the center corresponding to the fastening holes 313 of the fastening seat 31 to be engaged with fastening elements 353 such as screws for fastening.

The clipping plate assembly 40 aims to clip a glass panel 60, and mainly has a first clip plate 41 and a second clip plate 42 that are coupled together, two pads 43 held on an inner side of the first and second clip plates 41 and 42, and a clipping blade 44 to hold and confine two directing members 45.

The first clip plate 41 has a first recess 410 on the inner side and a fastening boss 411 extended from the inner side and formed in a shape like the first clip plate 41. An indented portion 4111 at an inner side of the fastening boss 411 to hold the fastening seat 31. The fastening boss 411 has two opposing latch troughs 412 to hold the stems 342 at the upper end and lower end of the pintle 34 and the two directing members 45. At one side of the fastening boss 411, there are a first and a second screw holes 413 formed vertically thereon leading to the latch troughs 412. Through two adjusting screws 414, the two directing members 45 can be pressed and moved. The fastening boss 411 further has two corresponding pin holes 415 formed at the upper and lower end surface thereof, and fastening holes 416 at two corresponding ends at the outer side.

The second clip plate 42 has a second recess 420 on an inner side corresponding to the first recess 410 of the first clip plate 41, and a plurality of sunken holes 421 close to one side to allow screwing elements 422 to run through and fasten to the fastening holes 416 of the first clip plate 41 to screw the first and second clip plates 41 and 42 together.

The two pads 43 are formed in a shape same as the first and second recesses 410 and 420 to be wedged in them respectively.

The clipping blade 44 is formed in a shape to clip the fastening boss 411 on the periphery. It has a longitudinal side 441 with an upper end and a lower end formed respectively a curved bend side 442 and 443, and two opposing clipping sides 444 and 445 extended vertically from the longitudinal side. The clipping sides 444 and 445 have respectively two pins 446 corresponding to the two pin holes 415.

The two directing members 45 are held at one end of the two latch troughs 412 and pressed by the clipping blade 44 to be positioned. They have a bottom confined by the two sealing caps 343 of the fastening seat 31. Each of the directing members 45 has a curve 451 at one end to press the stem 342 at the upper end and lower end of the pintle 34, and a plane 452 on an outer side to be pressed by the two adjusting screws 414 to do fine tuning so that the two directing members 45 can be moved in the two latch troughs 412 and form a pressing or releasing contact with the stem 342 at the upper and lower end of the pintle 34.

By means of the construction set forth above, when in use, referring to FIGS. 4A, 4B and 4C, the seat board 35 is fastened to the door frame 50, the first and second clip plates 41 and 42 are coupled and fastened together through the screwing elements 422 at lateral sides of the glass panel 60 so that the glass panel 60 can be swiveled about the pintle 34 as an axis. The two bucking elements 32 and elastic elements 33 and the flat surface 341 of the pintle 34 form a pressed and mating structure so that the glass panel 60 can be swiveled to a preset position and anchored. The relative position of the glass panel 60 and the door frame 50 can be adjusted after swiveled and opened through the adjusting screws 414 in the first and second screw holes 413 of the fastening boss 411.

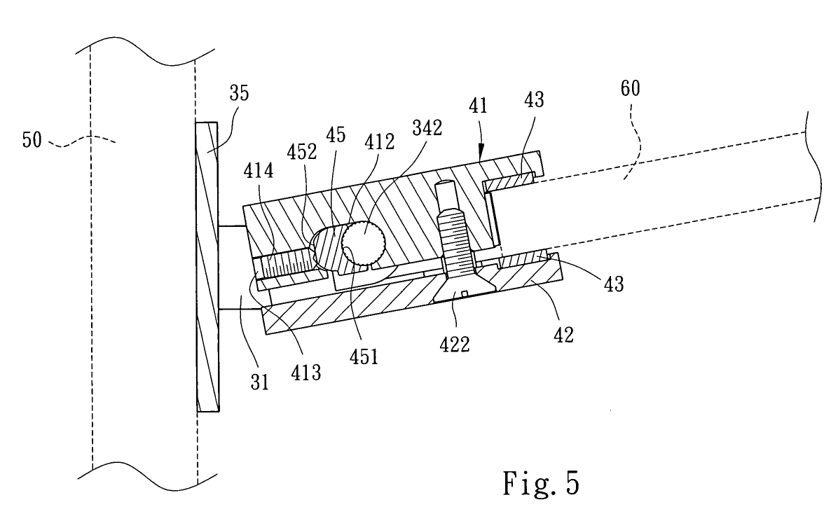

Referring to FIG. 5, after the glass panel 60 has been installed on the door frame 60, if it is found that the glass panel 60 is tilted or cannot be fully aligned with the door frame 50, through the hinge of the invention a fine tuning can be made to adjust the position of the glass panel 60 relative to the door frame 50.

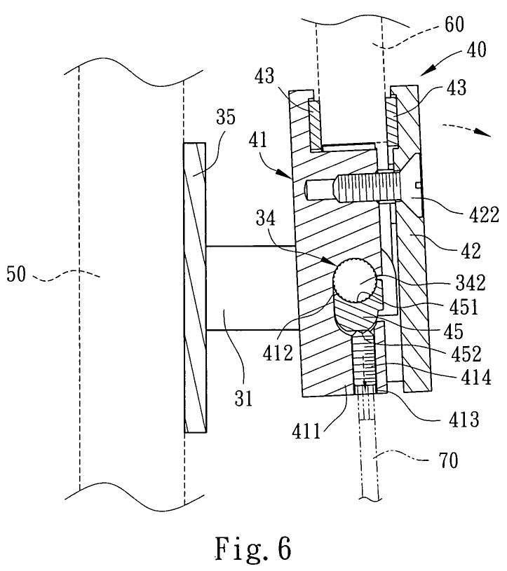

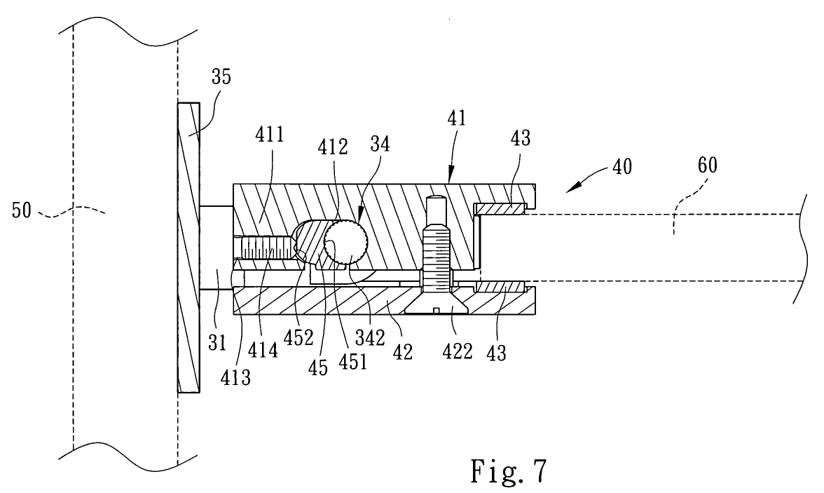

Referring to FIGS. 6 and 7, first, move the glass panel 60 in parallel with the door frame 50 in an open condition with the adjusting screws 414 at one side of the first clip plate 41 exposed from the original hidden condition; through a tool 70 the adjusting screws 414 fastened to the fastening boss 411 can be unfastened to separate the stems 342 at the upper and lower ends of the pintle 34 from the clamping curves 451 of the two directing members 45; then the glass panel 60 can be moved manually and aligned with the door frame 50; finally fasten the adjusting screws 414 again to move the two directing members 45 in the two latch troughs 412 so that the curves 451 once again press the stems 342 of the pintle 34 to allow the clipping assembly 40 and the pintle 34 to be coupled together. Thus fine tuning of the relative position of the glass panel 60 and the door frame 50 can be accomplished quickly.

In short, by means of the adjustable glass hinge of the invention the glass panel 60 can be adjusted and aligned by unfastening the adjusting screws 414 on the inner side of the fastening boss 411 through the tool 70 to separate the two directing members 45 from the stems 342 at the upper end and lower end of the pintle 34; then the relative position of the glass panel 60 and the door frame 50 can be fine tuned manually; and the adjusting screws 414 can be fastened again to clamp the stems 342 at the upper and lower ends of the pintle 45 with the curves 451 of the two directing members 45. Thus fine tuning and aligning of the glass panel 60 can be performed quickly. The adjusting process is simpler and easier.

What is claimed is:

1. An adjustable glass hinge, comprising:
a fastening assembly which has a fastening seat with a pintle hole at one side and two opposing through holes at another side that are formed vertically leading to the pintle hole, two bucking elements disposed in the fastening seat from one side thereof and coupled respectively with an elastic element and movable in the through holes, a pintle running through the pintle hole and a seat board fastened to the fastening seat and a door frame; and
a clipping assembly which has a first clip plate and a second clip plate, two pads and a clipping blade that are coupled together; the first clip plate having a fastening boss extended from an inner side that has two opposing latch troughs to hold stems formed at an upper end and a lower end of the pintle and two directing members, the fastening boss further having a first screw hole and a second screw hole formed vertically leading to the two latch troughs from one side thereof to be engaged with two adjusting screws to press the two directing members to move so that the stems of the pintle are pressed tightly or loosened; the second clipping plate being coupled with the first clipping plate by screwing, the two pads being held on an inner side of the first and second clip plates, the clipping blade being formed in a profile to clip the periphery of the fastening boss and confine the two directing members.

2. The adjustable glass hinge of claim 1, wherein each of the bucking elements has a pressing head at one end and a strut at another end formed at a diameter smaller than the pressing head.

3. The adjustable glass hinge of claim 1, wherein the pintle has a flat surface on the periphery in a middle portion, the stems being extended from the upper end and the lower end of the pintle to be coupled respectively with a sealing cap held in the pintle hole of the fastening seat, the sealing cap having one end surface pressed by the directing member at a lower side.

4. The adjustable glass hinge of claim 3, wherein the sealing cap has a jutting ring extended from one end thereof that has an aperture formed thereon.

5. The adjustable glass hinge of claim 1, wherein the first clip plate has a first recess on an inner side thereof.

6. The adjustable glass hinge of claim 1, wherein the fastening boss has two corresponding pin holes at an upper end and a lower end thereof.

7. The adjustable glass hinge of claim 1, wherein the second clip plate has a second recess on an inner side thereof.

8. The adjustable glass hinge of claim 1, wherein the clipping blade includes a longitudinal side which has curved bend sides at an upper end and a lower end thereof that are extended vertically therefrom to form two opposing clipping sides, each of the clipping sides having an inner side which has two corresponding pins located thereon.

9. The adjustable glass hinge of claim 1, wherein each of the directing members has a curve at one end and a plane on the periphery of another end thereof.
